(19) United States
(12) Patent Application Publication
(10) Pub. No.: US 2009/0116049 A1
(43) Pub. Date: May 7, 2009

(54) Apparatus and method for processing images and program fro the same

(75) Inventors: Junichi Takenuki, Sapporo (JP); Satoshi Yamada, Suwa-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/290,897

(22) Filed: Nov. 5, 2008

(30) Foreign Application Priority Data
Nov. 5, 2007 (JP) 2007-287339

(51) Int. Cl. H04N 1/60

(52) U.S. Cl. 358/1.9; 358/1.16

(57) ABSTRACT

An image processing apparatus includes a storage section that can provide more than one storage area for storing print data for use in printing; a conversion section that converts image data to the print data; and a storage control section configured to, when printing multiple copies of multiple images, store print data that takes longer to convert in the storage section in accordance with conversion times taken to convert the individual pieces of print data.

The entire disclosure of Japanese Patent Application No. 2007-287339, filed Nov. 5, 2007 is expressly incorporated by reference herein.

### BACKGROUND

1. Technical Field

The present invention relates to an apparatus and method for processing images and a program for the same.

2. Related Art

One example of known image processing apparatuses extracts print data received from a host computer from a receive buffer and sends the print data to a print mechanism in sequence and, in parallel, stores it in a compressed state in a hard disk serving as a memory so that, even if printing is interrupted after or during printing, the print data can be printed by uncompressing the print data stored in the hard disk without sending the print data again (for example, refer to JP-A-10-228358).

However, this image processing apparatus described in JP-A-10-228358 needs many storage areas to store all the print data in the memory although the print data is stored in a compressed state. Moreover, the print data needs to be uncompressed because it is stored in a compressed state. Therefore, reduction of processing time is required.

### SUMMARY

An advantage of some aspects of the invention is to provide an apparatus and method for processing images in which storage areas to be used are reduced and in which its processing time is reduced and a program for the same.

To provide the above advantages, the invention adopts the following means.

According to a first aspect of the invention, there is provided an image processing apparatus including a storage section that can provide more than one storage area for storing print data for use in printing; a conversion section that converts image data to the print data; and a storage control section configured to, when printing multiple copies of multiple images, store print data that takes longer to convert in the storage section in accordance with conversion times taken to convert the individual pieces of print data.

This image processing apparatus is configured to, when printing multiple copies of multiple images, convert image data to print data for use in printing and to store print data that takes longer to convert in a storage section, which has storage areas having more than one predetermined number of memories for storing the print data, in accordance with conversion times taken to convert the individual pieces of print data. Thus, this apparatus stores print data that takes longer to convert in the storage section on a priority basis and uses the stored print data for the subsequent printing. Thus, this configuration can reduce the number of storage areas and the processing time.

In this case, preferably, the conversion section can convert a plurality of pieces of image data in parallel; the storage section can use a predetermined number of conversion areas that are necessary for the conversion section to execute the conversion processing and an accumulation area that stores the print data as the storage areas; and the storage control section is configured to store print data determined according to the conversion times in the accumulation area while reserving the conversion area. This configuration can further reduce processing time because it stores print data that takes longer to convert while executing the process of converting image data to print data. Here, the conversion section may be able to convert 2n (n is an integer greater than 1) pieces of image data in parallel, and the storage section may have 2n conversion areas and 2n or more accumulation areas as the storage areas. The storage control section may be configured to, when the conversion area is absent, store the print data in the accumulation area while reserving the conversion area by erasing print data stored in the storage area and taking shorter to convert. This configuration further reduces processing time. The storage control section may be configured to, when the conversion section performs the conversion processing, store print data subjected to the conversion processing in the conversion area of the storage section and, when the conversion processing has finished, store the converted print data in the conversion area serving as the accumulation area. This configuration eliminates the need for moving converted print data to another area for storage, so that the storage area can be used more efficiently and processing load can be further reduced.

In the image processing apparatus, the conversion section may convert the image data to coloring-material-type page data serving as the print data which is the page data of the types of individual coloring materials; and the storage control section may be configured to store, as the print data, the coloring-material-type page data in the storage areas. This configuration further reduces storage areas to be used and the processing time by storing relatively versatile coloring-material-type page data.

In the image processing apparatus, the conversion section may convert the image data to coloring-material-amount page data serving as the print data which is the page data of the amounts of individual coloring materials; and the storage control section may be configured to store, as the print data, the coloring-material-amount page data in the storage areas. This configuration further reduces storage areas to be used and the processing time by storing coloring-material-amount page data that is used directly in printing.

The image processing apparatus may be configured such that the conversion section can convert the image data to coloring-material-type page data serving as the print data which is the page data of the types of individual coloring materials and can convert the image data to coloring-material-amount page data serving as the print data which is the page data of the amounts of individual coloring materials; the storage section has storage areas including a storage area provided at a print mechanism that executes printing and a hold area provided at a control unit that outputs data to the print mechanism; and the storage control section is configured to, in storing print data that takes longer to convert in the storage section, store the coloring-material-type page data in the hold area provided in the control unit and to store the coloring-material-amount page data in the storage area provided in the print mechanism. This configuration allows printing by different print mechanisms by storing relatively versatile coloring-material-type page data in the control unit that uses this data relatively generally and further reduce printing time by storing coloring-material-amount page data that is used directly for printing in the print mechanism that executes printing. In this case, the print mechanism may have a page-data conversion section that converts the coloring-material-type page data to the coloring-material-amount page data. The coloring-material-amount page data may be stored in the storage area after being subjected to conversion according to the characteristics of the print mechanism. In this case, the storage control section may be configured to store the coloring-material-amount page data that takes longer to convert the image data to the coloring-material-type page data in a storage area provided at the print mechanism and to store coloring-material-type page data, which takes the second longest to the coloring-material-amount page data stored in the storage area to convert the image data to the coloring-material-type page data, in the hold area provided at the control section. This configuration reduces conversion time by converting image data that takes longer to convert to coloring-material-amount page data that takes no time to convert and by storing it in the print mechanism and further reduces the number of storage areas to be used and the processing time by converting image data that take the second longest to coloring-material-type page data and storing it.

The image processing apparatus may further include a time measurement section that measures conversion times that the conversion section takes to convert individual pieces of image data to the print data; wherein the storage control section may be configured to store print data that takes longer to convert on the basis of the measured conversion times. This configuration further reduces the number of storage areas to be used using the accurate measured conversion times and the processing time.

The image processing apparatus may further include a time estimation section that estimates conversion times taken to convert the individual pieces of image data to the print data on the basis of at least one of the number and the kind of drawing instructions included in the image data; wherein the storage control section may be configured to store print data that takes longer to convert on the basis of the estimated conversion times. This configuration further reduces the number of storage areas to be used using the conversion times estimated from drawing instructions and the processing time.

The image processing apparatus may further include a print mechanism that executes printing on a print medium using print data stored in the storage section. This configuration allows printing of processed print data.

According to a second aspect of the invention, there is provided an image processing method using an image processing apparatus that includes a storage section having storage areas having more than one predetermined number of memories for storing print data for use in printing. The method includes (a) converting image data to the print data; and (b) when printing multiple copies of multiple images, storing print data that takes longer to convert in the storage section in accordance with conversion times taken to convert the individual pieces of print data.

This image processing method is configured to, when printing multiple copies of multiple images, convert image data to print data for use in printing and to store print data that takes longer to convert in a storage section, which has storage areas having more than one predetermined number of memories for storing the print data, in accordance with conversion times taken to convert the individual pieces of print data. Thus, this apparatus stores print data that takes longer to convert in the storage section on a priority basis and uses the stored print data for the subsequent printing. Thus, this configuration can reduce the number of storage areas to be used and the processing time. This image processing method may adopt various forms of the image processing apparatus and may have other process steps to achieve the functions of the image processing apparatus.

According to a third aspect of the invention, there is provided a program having computer readable program code for one or a plurality of computers to execute the image processing method. This program may be stored in a computer-readable recording medium (for example, a hard disk, a ROM, an FD, a DC, or a DVD). Alternatively, the program may be distributed from one computer to another computer via a transmission medium (a communication network such as the Internet or a LAN) or by another way. The same advantages as those of this image processing method are provided because the process steps of the image processing method can be executed when this program is executed by one computer or more than one computer.

### BRIEF DESCRIPTION OF THE DRAWINGS

The invention will be described with reference to the accompanying drawings, wherein like numbers reference like elements.

FIG. 1 is a schematic block diagram showing an example of the configuration of a printer of an embodiment.

FIG. 2 shows an example of the flowchart for a multiple-copy print setting routine.

FIG. 3 shows an example of the flowchart for a drawing-output processing routine.

FIG. 4 shows an example of the flowchart for a page-drawing and time-measurement processing routine.

FIG. 5 shows an example of the flowchart for a conversion print processing routine.

FIG. 6 is an image diagram showing temporal expansion processing.

FIG. 7 shows an example of the flowchart for another drawing-output processing routine.

FIG. 8 shows an example of the flowchart for another conversion print processing routine.

FIG. 9 is an image diagram showing temporal expansion processing and conversion processing.

FIG. 10 shows an example of the flowchart for another drawing-output processing routine.

FIG. 11 is an image diagram showing temporal expansion processing and conversion processing.

### DESCRIPTION OF EXEMPLARY EMBODIMENTS

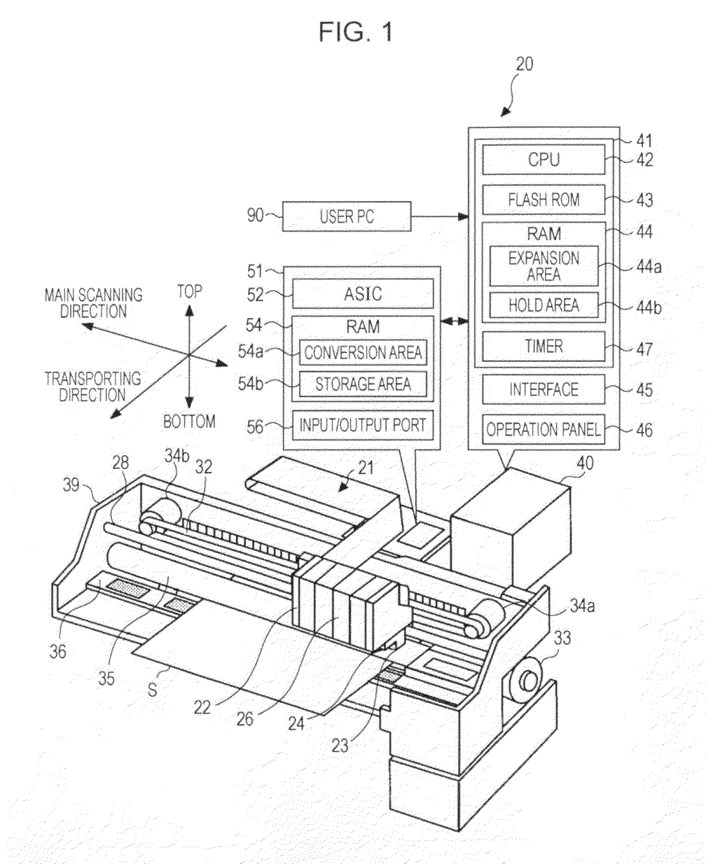

Embodiments of the invention will be described with reference to the drawings. FIG. 1 is a schematic block diagram showing an example of the configuration of a printer 20 of this embodiment. As shown in FIG. 1, the printer 20 of this embodiment includes a print mechanism 21 that ejects ink onto recording paper S, a paper feed roller 35 that is driven by a drive motor 33 to transport the recording paper S on the platen 36 from the back to the front in the drawing, and a control unit 40 that controls the whole of the printer 20.

The print mechanism 21 includes a carriage 22 that is reciprocated by a carriage belt 32 from side to side (in the main scanning direction) along a carriage shaft 28, a print head 24 that applies pressure to color inks so that fluid ink drops are ejected from nozzles 23, an ink cartridge 26 that holds color inks and supplies the held inks to the print head 24, and a print mechanism controller 51 that drives the print head 24 in accordance with data received from the control unit 40 to execute printing. The carriage 22 moves as the carriage belt 32, which is provided between a carriage motor 34a mounted at the right of a frame 39 and a driven roller 34b mounted at the left of the frame 39, is driven by the carriage motor 34a. The print head 24 is provided under the carriage 22 and ejects color inks from the nozzles 23 provided on the lower surface of the print head 24 by a system in which voltage is applied to an piezoelectric element so that the piezoelectric element is deformed to apply pressure to ink. The ink cartridge 26 is mounted on the carriage 22 and contains individual color inks for use in printing, such as cyan (C), magenta (M), yellow (Y), and black (K), in which pigments or coloring materials are mixed in water serving as a solvent. The print mechanism controller 51 includes an application-specific integrated circuit (ASIC) 52 having a circuit configuration to convert coloring-material-type page data output from the control unit 40 to coloring-material-amount page data and to drive the print head 24, a RAM 54 that stores data for use in ejecting ink from the print head 24, and an input/output port 56 for inputting and outputting various signals to/from the control unit 40. The coloring-material-type page data is page data generated by expanding print image data and decomposed into sheets of the individual colors (C, M, Y, and K) stored in the ink cartridge 26. The coloring-material-amount page data is page data generated from the coloring-material-type page data and converted to the amounts of individual colors of the pixels of the print image data. This coloring-material-amount page data is set to be converted as corrected data so as to match the characteristics of the print head 24 in consideration of the ease of discharge of inks from the individual color nozzles 23. Both the coloring-material-type page data and the coloring-material-amount page data are print data converted from image data. The ASIC 52 is configured to be able to perform more than one (in this case, two) processes of converting coloring-material-type page data to the coloring-material-amount page data in parallel. The RAM 54 dynamically holds a plurality of storage areas according to processes, such as a conversion area 54a that is used when the ASIC 52 converts the coloring-material-type page data to the coloring-material-amount page data and a storage area 54b for storing the generated coloring-material-amount page data. Here, the RAM 54 is designed to have a capacity ensuring areas to store two A2-size pages of data at the maximum.

As shown in FIG. 1, the control unit 40 includes a host controller 41 that controls the print mechanism 21 and so on, an interface 45 that exchanges information with an external unit, and an operation panel 46 having a display section that can display information to the user and an operating section with which user instructions can be entered. This host controller 41 is configured as a microprocessor mainly composed of a CPU 42 and includes a flash ROM 43 that can store various processing programs and can be reprogrammed, a RAM 44 that temporarily stores or holds data, a timer 47 used to measure a time interval, and an input/output port (not shown). The CPU 42 is constructed of a main CPU and a plurality of sub-CPUs (not shown), which are configured to execute a plurality of (here, two) image converting processes in printing in parallel. The flash ROM 43 stores various processing programs, such as a multiple-copy print setting routine, a drawing-output processing routine, and a page-drawing and time-measurement processing routine to be described later. The RAM 44 dynamically holds a plurality of storage areas according to processes, such as an expansion area 44a that is used to expand print image data to generate coloring-material-type page data and a hold area 44b for holding the coloring-material-type page data that is generated by expansion. The RAM 44 is designed to have a capacity ensuring an area to store two A2-size pages of data at the maximum. This host controller 41 receives an operation signal and so on from the operation panel 46 through an input port (not shown) and a print job, that is, image data, output from a user personal computer (PC) 90 through the interface 45. The host controller 41 outputs a control signal to the print head 24, a control signal to the drive motor 33, a drive signal to the carriage motor 34a, and a signal to the operation panel 46 through an output port (not shown).

Next, the operation of the printer 20 of this embodiment, particularly, in the case where multiple copies of image data having multiple pages are printed, will be described. First, the user sets print image data using the PC 90 to give a print instruction. Then, the control unit 40 of the printer 20 receives the print instruction and the image data sent from the PC 90 via the interface 45. Here, a concrete example in which multiple copies of A3-size image data having multiple pages are printed will be principally described.

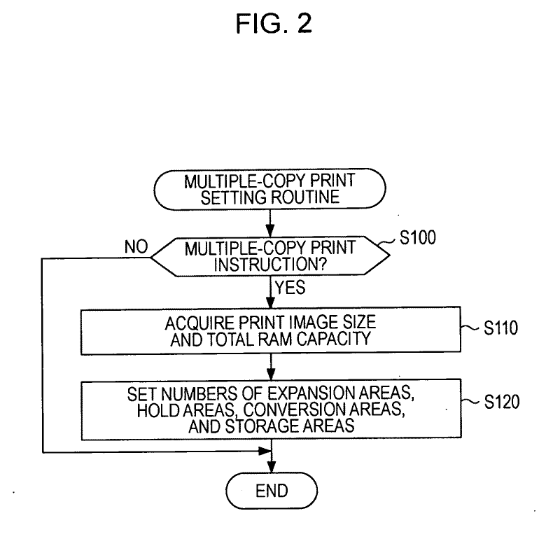

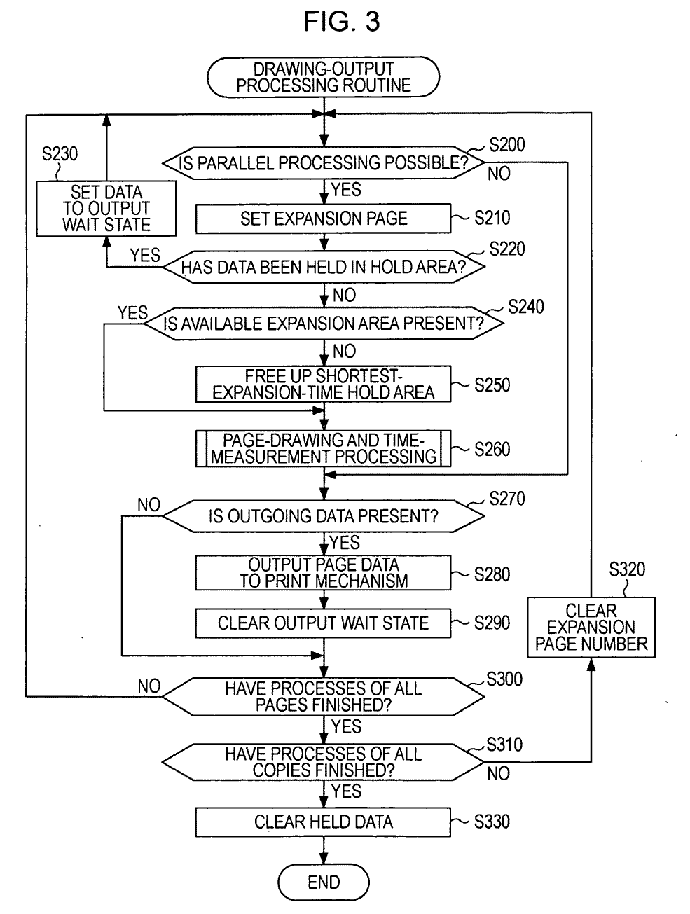

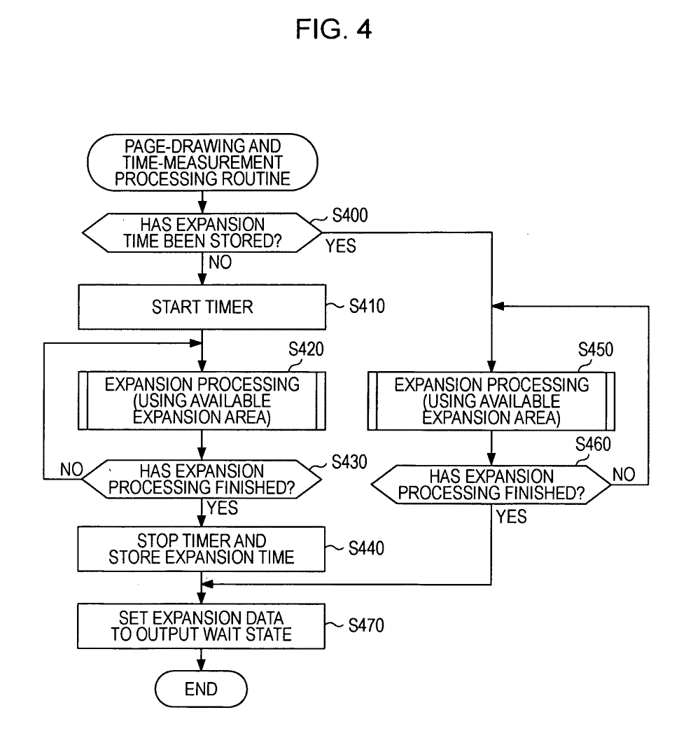

FIG. 2 shows an example of the flowchart for a multiple-copy print setting routine executed by the CPU 42 of the control unit 40. FIG. 3 shows an example of the flowchart for a drawing-output processing routine executed by the CPU 42 of the control unit 40. FIG. 4 shows an example of the flowchart for a page-drawing and time-measurement processing routine executed by the CPU 42 of the control unit 40. The multiple-copy print setting routine is repeatedly executed after the power of the printer 20 is turned on. When this routine is started, first, the CPU 42 determines whether a received print instruction is a multiple-copy print instruction (step S100). If the received print instruction is not a multiple-copy print instruction, then the CPU 42 terminates this routine. On the other hand, if the received print instruction is a multiple-copy print instruction, then the CPU 42 acquires a print image size from the print instruction and information on the present total available capacity of the RAM 44 (step S110). Next, the CPU 42 sets the expansion area 44a and the hold area 44b on the basis of the image size, the total capacity of the RAM 44, and the number of page data that the CPU 42 can process in parallel (step S120) and terminates this routine. Specifically, since the RAM 44 can store two pages of A2-size image data and the size of the print image data is A3, four pages of storage areas in total are reserved. Among them, two expansion areas 44a are reserved initially and the remaining storage areas are reserved as the hold area 44b since the number of data page that the CPU 42 can process in parallel is two. Likewise, the RAM 54 of the print mechanism controller 51 can store two pages of A2-size image data and the size of the print image data is A3, so that four pages of storage areas in total are reserved. Among them, two conversion area 54a are reserved initially and the remaining storage areas are reserved as the storage area 54b since the number of data page that the ASIC 52 can process in parallel is two. Thus, for multiple-copy printing, the space of the RAM 44 is reserved so as to store print data.

After the multiple-copy print setting routine, the image data is converted to print data, such as coloring-material-type page data or coloring-material-amount page data, and printing is executed. Here, a first embodiment will be described in which the printer 20 executes printing of multiple copies of multiple pages while storing print data in the RAM 44 of the host controller 41; a second embodiment will be described in which the printer 20 executes printing of multiple copies of multiple pages while storing print data in the RAM 54 of the print mechanism controller 51; and a third embodiment will be described in which the printer 20 executes printing of multiple copies of multiple pages while storing print data in the RAM 44 of the host controller 41 and the RAM 54 of the print mechanism controller 51.

### First Embodiment

First, the first embodiment will be described in which the printer 20 executes printing of multiple copies of multiple pages while storing print data in the RAM 44 of the host controller 41. After reserving the storage spaces of the RAM 44 and the RAM 54 in the multiple-copy print setting routine, the CPU 42 executes the drawing-output processing routine shown in FIG. 3. When this routine is started, the CPU 42 determines whether expansion processing for expanding received image data to coloring-material-type page data (hereinafter simply referred to as expansion processing) can be executed in parallel (step S200). This is a determination on whether one or more piece of data can be expanded from the number of data being expanded. Here, also when coloring-material-type page data in a print-mechanism-21 output wait state is present, the CPU 42 determines that expansion processing cannot be executed in parallel. The expansion processing is placed in the wait state because coloring-material-type page data in its output wait state is generated when the print mechanism 21 has some data in its print wait state. If it is determined that expansion processing can be executed in parallel, then the CPU 42 sets an expansion page that is to be expanded from image data to the coloring-material-type page data (step S210), and determines whether the set coloring-material-type page data has already been held in the hold area 44b (S220). The expansion page is determined to be set from the first page of the image data in sequence. As will be described in detail, the hold area 44b is set to hold image data that takes longer to expand from image data to the coloring-material-type page data.

If the set coloring-material-type page data is not held in the hold area 44b, the CPU 42 determines whether an available expansion area 44a is present (step S240). If an available expansion area 44a is absent, the CPU 42 frees up one of the hold areas 44b that hold coloring-material-type page data that takes the shortest to expand and uses this freed-up space is as the expansion area 44a (step S250). If the plurality of hold areas 44b has a free space, the CPU 42 uses the free space as the expansion area 44a. Thus, coloring-material-type page data that takes longer to expand is left in the RAM 44 by erasing coloring-material-type page data that takes shorter to expand. If an available expansion area 44a is present after step S250 or in step S240, the CPU 42 executes the page-drawing and time-measurement processing routine shown in FIG. 4 (step S260). The description of the drawing-output processing routine is interrupted and the page-drawing and time-measurement processing routine will be described hereinbelow.

When this routine is started, the CPU 42 determines whether the expansion time of target image data has been stored (step S400). Here, a list of the expansion times of an image data group for multiple-copy printing is stored in a specified area of the RAM 44, and the CPU 42 determines whether the expansion time has been stored from the description of this list. If no expansion time has been stored, a timer 47 is started (step S410), and expansion processing is executed in the available expansion area 44a (step S420). This expansion processing decompresses compressed image data (a JPEG file etc.) received from the user PC 90 and divides the data into four color sheets, for example, cyan (C), magenta (M), yellow (Y), and black (B). Here, the individual color sheets are each handled as one image unit. Subsequently, the CPU 42 determines whether the expansion processing has finished (step S430). If the expansion processing has not finished, the expansion processing is continued in step S420. If the expansion processing has finished, the CPU 42 stops the timer 47 and stores measured expansion time in the above-mentioned list in the RAM 44 (step S440). On the other hand, if it is determined in step S400 that the expansion time of the target image data has been stored, the CPU 42 executes expansion processing without measuring expansion time with the timer 47 (step S450), and the CPU 42 determines whether the expansion processing has finished (step S460). If the expansion processing has not finished, the expansion processing is continued in step S450. If the expansion processing has finished in steps S430 and S460, the CPU 42 sets the expanded coloring-material-type page data to a print-mechanism-21 output wait state (step S470) and terminates this routine. Here, the expansion area 44a in which expansion processing is executed is changed to the hold area 44b, in which the expanded coloring-material-type page data is held. In this way, the expansion times of the image data of the individual pages are measured and the expanded coloring-material-type page data is held in the hold area 44b. Here, coloring-material-type page data that takes the shortest to expand is erased in step S250 of the drawing-output processing routine, so that coloring-material-type page data that takes longer to expand is held in the hold area 44b.

In the drawing-output processing routine, after the process of step S260 is executed or after it is determined in step S200 that expansion processing cannot be executed in parallel, the CPU 42 determines whether outgoing coloring-material-type page data is stored in the RAM 44 (step S270). Here, coloring-material-type page data in the first output wait state is determined to be outgoing coloring-material-type page data. If outgoing coloring-material-type page data is present, this data is output to the print mechanism controller 51 of the print mechanism 21 (step S280), and the output wait state that is set to the output data is cleared (step S290). Here, the process is set to bring the print image data into the output wait state in order of pages, so that the print mechanism 21 executes print processing in order of the pages of the print image data.

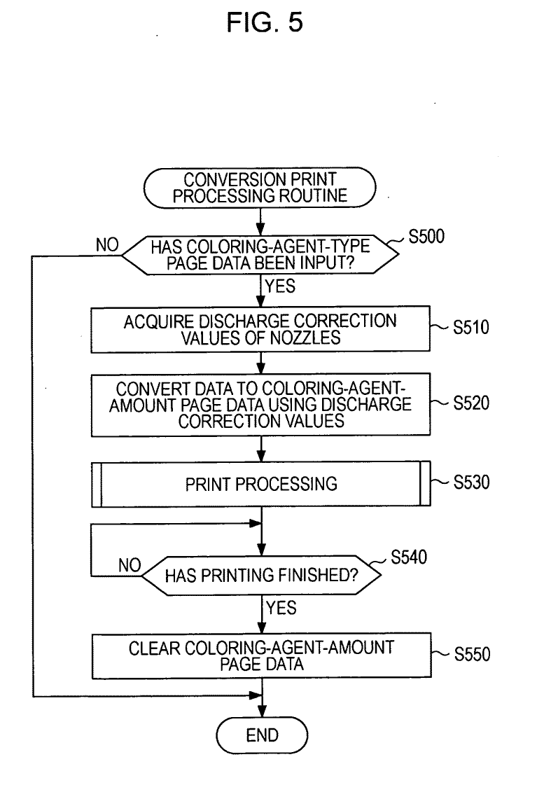

Now, the process of the print mechanism 21 that received the output coloring-material-type page data will be described. After the printer 20 is started, the ASIC 52 of the print mechanism controller 51 (see FIG. 1) repeatedly executes the conversion print processing routine shown in FIG. 5. This routine is executed by a circuit that constitutes the ASIC 52. When this routine is started, the ASIC 52 determines whether coloring-material-type page data has been input (step S500). If no coloring-material-type page data has been input, the ASIC 52 terminates this routine. In contrast, if coloring-material-type page data has been input, the ASIC 52 acquires discharge correction values stored in a ROM (not shown) and corresponding to the individual nozzles 23 (step S510). These discharge correction values are empirically set to values such that the ease of discharge of ink from the nozzles 23 is determined at, for example, inspection prior to shipment, with which the same print results are provided by the individual printers 20. Next, the ASIC 52 executes the process of converting the input coloring-material-type page data to coloring-material-amount page data indicative of the amounts of inks to be discharged from the nozzles 23 using the determined discharge correction values (hereinafter simply referred to as conversion processing) (step S520). Subsequently, the ASIC 52 executes print processing using the converted coloring-material-amount page data (step S530). In this print processing, the ASIC 52 drives the drive motor 33 to rotate the paper feed roller 35 and so on to transport the recording paper S to a printable area on the platen 36 and drives the carriage motor 34a to move the carriage 22 in the carriage moving direction to eject ink, or coloring materials, onto the recording paper S according to the coloring-material-amount page data. Subsequently, the ASIC 52 determines whether printing has finished (step S540). If the printing has not finished, the ASIC 52 continues the printing processing. If the printing has finished, the ASIC 52 clears the coloring-material-amount page data from the RAM 54 (step S550) and terminates this routine. In this way, when coloring-material-type page data is input, the print mechanism 21 executes print processing.

In the drawing-output processing routine, if coloring-material-type page data in its output wait state is absent after step S290 or in step S270, the CPU 42 determines in step S300 whether the expansion processing and output processing of all the pages of the image data have finished. If the processing operations on all the pages have not finished, the CPU 42 repeatedly executes the operations from step S200. That is, if parallel processing is possible in step S200, it is determined in step S240 whether an available expansion area 44a is present. If there is no available expansion area 44a, the CPU 42 erases coloring-material-type page data which is held in the hold area 44b and takes the shortest and executes expansion processing of two images in parallel using this area as the expansion area 44a in step S260. The case where parallel processing is possible and an available expansion area 44a is absent is, for example, in the above concrete example in which four storage areas are provided in the RAM 44, a case in which expansion processing is being executed in one expansion area 44a, while one expansion processing operation has finished and three expansion processing operations have finished so that three pieces of coloring-material-type page data are held. Subsequently, after execution of expansion processing or when parallel processing is not possible, that is, while expansion processing operations are being executed in parallel, and if coloring-material-type page data in its output wait state is held in the hold area 44b in step S270, the coloring-material-type page data is output to the print mechanism 21 in step S280. This process is repeatedly executed.

On the other hand, if it is determined in step S300 that the above process has finished for all the pages, the CPU 42 determines whether the above process has finished for all the copies (step S310). If the process has not finished for all the copies, the CPU 42 clears the expansion page set in step S210 to move to the top page (step S320) and repeatedly executes the processes from step S200. At that time, coloring-material-type page data that takes longer to expand which is stored in the hold area 44b is placed in the output wait state in step S230 to omit expansion processing, thereby reducing processing time. On the other hand, if the above process for all the copies has finished in step S310, the CPU 42 clears the images held in the hold area 44b (step S330) and terminates this routine. Here, expansion time sometimes changes greatly from image data to image data according to their contents and the degree of compression. On the other hand, coloring-material-type page data after expansion has substantially the same data amount irrespective of the contents because they are uncompressed. This embodiment is configured to dynamically set a plurality of storage areas irrespective of image data and to hold coloring-material-type page data that takes longer to expand in the RAM 44 and to use this data for the second and consecutive print processing operations, thereby reducing processing time with the limited storage areas.

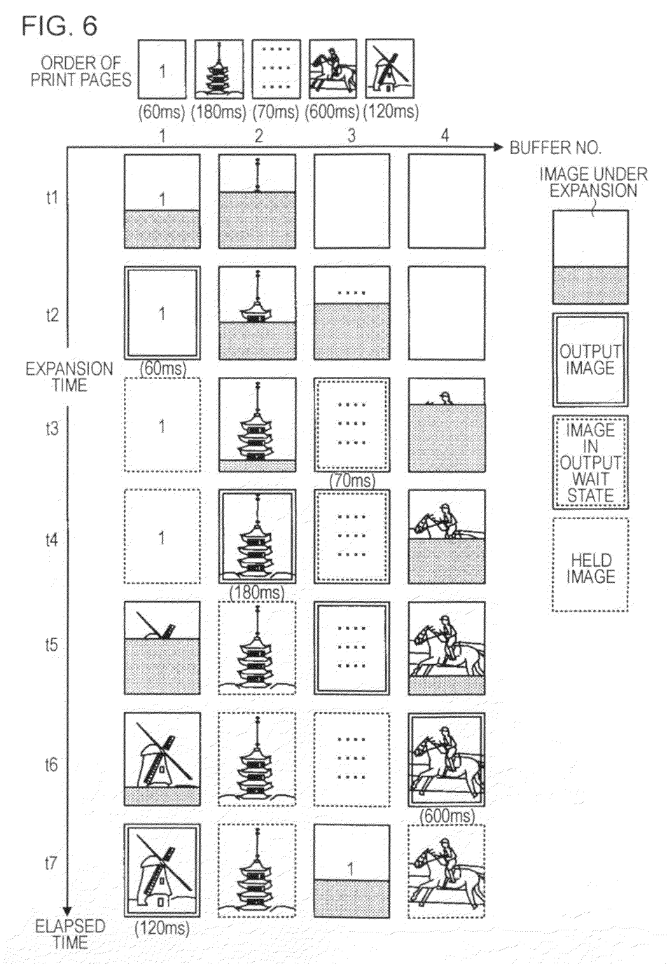

The above process will be described using a concrete example. FIG. 6 is an image diagram showing temporal expansion processing. FIG. 6 shows a case in which multiple copies of five pieces of image data are printed. In FIG. 6, individual storage areas are numbered and arranged in column; and data under expansion is shaded; output data is framed with an inside solid line; data in its output wait state is framed with an inside dotted line; and held data is framed with an outside dotted line so that differences in state are expressed. Although coloring-material-type page data is composed of color sheets, FIG. 6 shows the data using images for the convenience of description and ease of understanding. The following description is given the step numbers of the above-described routines. First, when a print instruction is given, the CPU 42 executes a first-image expansion process and also a second-image page-drawing and time-measurement process because parallel processing is possible (S260, t1). At that time, the expansion times of the first and second images are measured by the timer 47. When the first-image expansion process that takes shorter to expand has finished, the CPU 42 outputs the data to the print mechanism 21 and stores its expansion time (60 ms) in the RAM 44 (S280 and S440). At that time, the CPU 42 executes a third-image expansion process because parallel processing is possible (S260, t2). Subsequently, the CPU 42 holds the area in which the data of expanded first image is stored as the hold area 44b, and when the third-image expansion process that takes shorter has finished, the CPU 42 stores its expansion time (70 ms) in the RAM 44. At that time, the expanded third-image data is placed in the output wait state because the second image is under expansion, and the CPU 42 executes a fourth-image expansion process (t3). When the second-image expansion process has finished, the CPU 42 stores its expansion time (180 ms) in the RAM 44 and outputs the expanded data (t4), and then the CPU 42 executes a third-image output process (t5). At that time, since parallel processing is possible and an available expansion area 44a is absent, the CPU 42 frees up the hold area 44b that stores image data that takes the shortest to expand, here, the first image, to be used as the expansion area 44a and executes a fifth-image expansion process (t5). When the fourth-image expansion process has finished, the CPU 42 stores its expansion time (600 ms) in the RAM 44 and outputs the expanded data (t6). At that time, since parallel processing is possible and an available expansion area 44a is absent, the CPU 42 frees up the hold area 44b that stores image data that takes the shortest to expand, here, the third image, to be used as the expansion area 44a and executes the first-image expansion process (t7). At that time, the CPU 42 terminates the fifth-image expansion process, stores its expansion time (120 ms) in the RAM 44, and outputs the expanded data (t7). Thus, the printer 20 of the first embodiment stores data that takes longer to expand so as to reduce expansion processing time with limited storage capacity.

The printer 20 of the first embodiment, described in detail above, is configured, in printing multiple copies of a plurality of images, to expand image data to coloring-material-type page data and to store coloring-material-type page data that takes longer to expand in the RAM 44 having two or more storage areas (the expansion area 44a and the hold area 44b). Thus, the printer 20 stores coloring-material-type page data that takes longer to expand in the RAM 44 on a priority basis and uses this stored page data for the next printing process. This reduces the storage area of the RAM 44 to be used and the processing time as compared with those that hold all the coloring-material-type page data. Moreover, since the printer 20 stores data in the hold area 44b while reserving the expansion area 44a for expanding a plurality of pieces of image data in parallel, the printer 20 can reduce processing time by storing data that takes longer to expand while executing the process of expansion to coloring-material-type page data. Furthermore, when an available expansion area 44a is absent, the hold area 44b in which coloring-material-type page data that takes the shortest to expand is freed up into the expansion area 44a, so that processing time can easily be reduced. Furthermore, when the expansion process has finished, the printer 20 stores the expanded coloring-material-type page data in the expansion area 44a serving as the hold area 44b. This eliminates the need for moving expanded data to another area to store it. This allows storage areas to be used efficiently and reduces processing load and, moreover, reduces storage areas to be used by storing relatively versatile coloring-material-type page data and further reduces processing time. Furthermore, since the printer 20 stores coloring-material-type page data that takes longer to expand using expansion time measured by the timer 47, storage areas to be used can be decreased more and processing time can be reduced more using the measured expansion time. Since the printer 20 is equipped with the print mechanism 21, the printer 20 can execute printing soon using the coloring-material-amount page data converted using expanded coloring-material-type page data.

### Second Embodiment

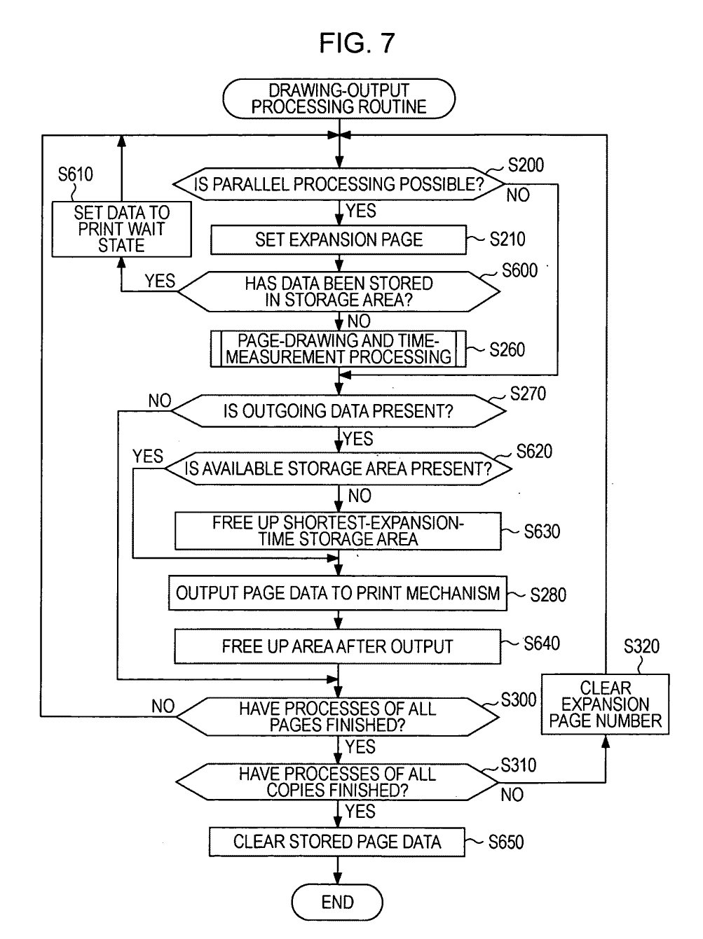

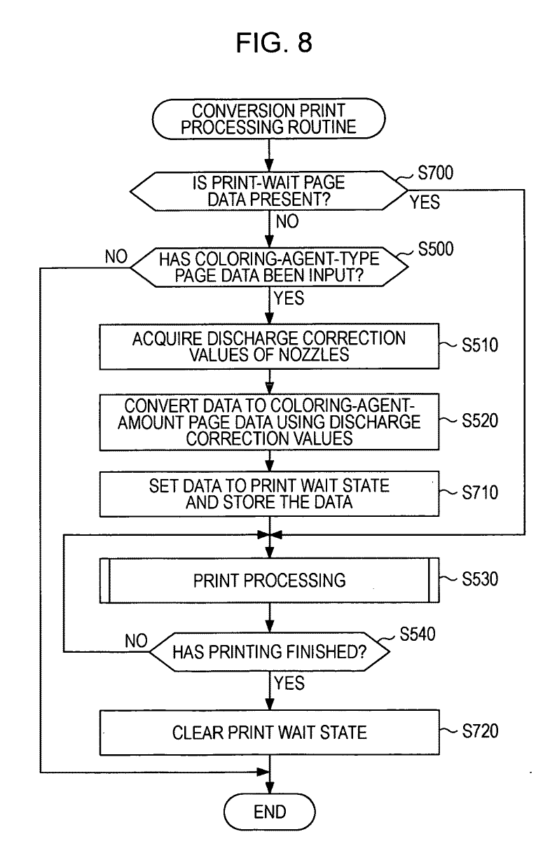

A second embodiment will be described in which the printer 20 executes printing of multiple copies of multiple pages while storing print data in the RAM 54 of the print mechanism controller 51. The host controller 41 executes the process of expanding image data to coloring-material-type page data. The ASIC 52 executes the process of converting the coloring-material-type page data to coloring-material-amount page data and the process of storing the coloring-material-amount page data in the storage area 54b on the basis of expansion time. The expansion time varies greatly depending on the content of image data, while the conversion time hardly varies. Therefore, the coloring-material-amount page data is stored on the basis of not conversion time but expansion time. FIG. 7 shows an example of the flowchart for the drawing-output processing routine of the second embodiment executed by the CPU 42 of the control unit 40. FIG. 8 shows an example of the flowchart for the conversion print processing routine of the second embodiment executed by the ASIC 52 of the print mechanism controller 51. Processes similar to the drawing-output processing routine shown in FIG. 3 and the conversion print processing routine shown in FIG. 5 are given the same signs and their descriptions will be omitted. When the drawing-output processing routine of FIG. 7 is started, first, the CPU 42 determines in step S200 whether parallel processing is possible. If the parallel processing is possible, the CPU 42 sets an expansion page in step S210 and determines whether the coloring-material-amount page data of this set expansion page has been stored in the storage area 54b of the RAM 54 of the print mechanism controller 51 (step S600). If this coloring-material-amount page data has been stored in the storage area 54b, then the CPU 42 sets this page data into a print wait state (step S610) and executes the processes from step S200.

In contrast, if this coloring-material-amount page data has not been stored in the storage area 54b, then, in step S260, the CPU 42 executes the page-drawing and time-measurement processing routine shown in FIG. 4 to expand the image data to coloring-material-type page data and determines in step S270 whether outgoing coloring-material-type page data is stored in the RAM 44. If outgoing coloring-material-type page data is present, then the CPU 42 determines whether the RAM 54 has an available conversion area 54a in which conversion processing can be executed (step S620). If an available storage area 54b is absent, the CPU 42 frees up one of the storage areas 54b in which coloring-material-amount page data that takes the shortest to expand is stored and uses this freed-up area as the conversion area 54a (step S630). If the plurality of storage areas 54b have a free space, the free space is used as the conversion area 54a. In this way, coloring-material-amount page data that takes the shortest to expand is erased so that coloring-material-amount page data that takes longer to expand is stored in the RAM 54. When an available conversion area 54a is present after step S630 or in step S620, the CPU 42 outputs coloring-material-type page data to the RAM 54 of the print mechanism controller 51 in the print mechanism 21 in step S280 to erase the output coloring-material-type page data, thereby freeing up the area after the outputting (step S640).

The process of the print mechanism 21 which has received the output coloring-material-type page data will be described hereinbelow. After the printer 20 is started, the ASIC 52 of the print mechanism controller 51 (see FIG. 1) repeatedly executes the conversion print processing routine shown in FIG. 8. When this routine is started, the ASIC 52 determines whether coloring-material-amount page data in the print wait state is stored in the RAM 54 (step S700). If the data that was set in the print wait state in step S610 has been stored, the data is printed in step S530. If no data in the print wait state is present, the ASIC 52 determines in step S500 whether coloring-material-type page data has been input. If no coloring-material-type page data has been input, the ASIC 52 terminates this routine. In contrast, if coloring-material-type page data has been input, the ASIC 52 acquires discharge correction values in step S510, executes the process of converting the data to coloring-material-amount page data using the discharge correction values in step S520, and sets the converted data to the print wait state and stores the data in the RAM 54 (step S710) and, in step S530, executes print processing using the coloring-material-amount page data. Next, if the printing has not finished in step S540, the print processing is continued. If the printing has finished, the ASIC 52 clears the print wait state (step S720) and terminates this routine. Thus, upon reception of coloring-material-type page data, the ASIC 52 converts the data to coloring-material-amount page data and stores it in the RAM 54, and the print mechanism 21 executes printing.

In the drawing-output processing routine, when no outgoing data is present after step S640 or in step S270, the CPU 42 determines in step S300 whether the expansion process, the output process, and conversion process have finished for all the pages of image data. If the processes have not finished for all the pages, then the CPU 42 repeatedly executes the processes from step S200. In contrast, if it is determined that the above processes have finished for all the pages, then the CPU 42 determines in step S310 whether the above processes have finished for all the copies. If the processes have not finished for all the copies, then the CPU 42 clears the expansion page number in step S320 to move to the top page and repeatedly executes the processes from step S200. That is, coloring-material-amount page data that takes longer to expand which is stored in the storage area 54b is placed in the print wait state in step S610 to omit expansion processing and conversion processing, thereby reducing processing time. On the other hand, if the above processes for all the copies have finished in step S310, the then the CPU 42 clears coloring-material-amount page data stored in the storage area 54b (step S650) and terminates this routine. Thus, this embodiment is configured to dynamically set a plurality of storage areas to store coloring-material-amount page data that takes longer to expand in the RAM 54 and to use this data for the second and consecutive print processing, thereby reducing processing time with the limited storage areas.

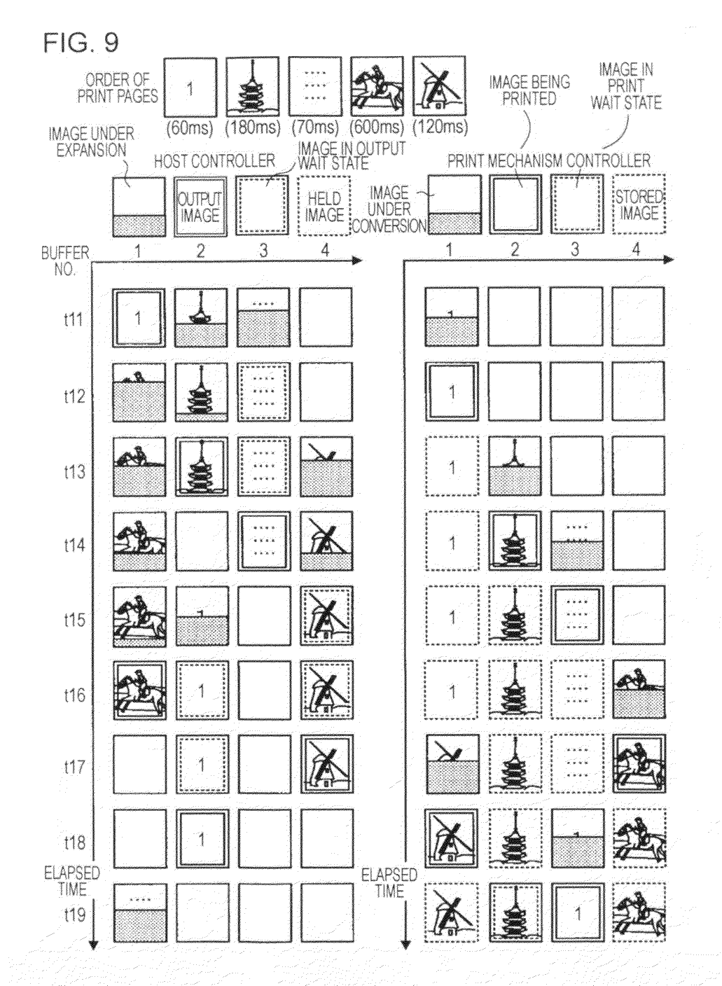

The above processes will be described using a concrete example. FIG. 9 is an image diagram showing temporal expansion processing and conversion processing. Here, expansion processing similar to that of FIG. 6 is shown by the same way as in FIG. 6, in which the host controller 41 which executes expansion processing is shown at the left of the drawing and the print mechanism controller 51 which executes conversion processing is shown at the right of the drawing. Data under conversion is shaded; data during printing is framed with an inside solid line, data in the print wait state is framed with an inside dotted line; and held data is framed with an outside dotted line so that differences in state are expressed. Although the coloring-material-amount page data is composed of data of the amounts of color inks of individual pixels, FIG. 9 shows it using images for the convenience of description and ease of understanding. The following description is given the step numbers of the above-described routines, and descriptions of measurement of expansion time will be omitted. First, when a print instruction is given, the CPU 42 executes a first-image expansion process and also a second-image expansion process because parallel processing is possible. When the first-image expansion process has finished, the CPU 42 outputs the first image data to the print mechanism controller 51 to erase the data from the expansion area 44a and executes a third-image expansion process (S280, S640, and S260, t11). In response to that, the ASIC 52 executes the process of converting the coloring-material-type page data of the first image to coloring-material-amount page data (S520). Subsequently, the ASIC 52 terminates the first-image conversion process and stores the converted first image data in the storage area 54b and prints the first image (S710 and S530, t12). At that time, the CPU 42 has finished the process of expanding the third image that takes shorter to expand and continues the second-image expansion process, so that the CPU 42 places the page data of the third mage in the output wait state (S470) and starts a fourth-image expansion process (S260, t12). Next, when the second-image expansion process has finished, the CPU 42 outputs the second image data to erase it from the expansion area 44a, continues the fourth-image expansion process, and starts a fifth-image expansion process (t13). At that time, the ASIC 52 executes the process of converting the page data of the input second image (S520, t13). Subsequently, the CPU 42 outputs the expanded page data of the third image in its output wait state to erase the data from the expansion area 44a and continues the process of expanding the fourth and fifth images (t14). At that time, the ASIC 52 stores the converted second image in the storage area 54b and executes printing and the process of converting the page data of the input third image (t14). Subsequently, the CPU 42 terminates the process of expanding the fifth image that takes shorter to expand and places the fifth image in the output wait state because the fourth-image expansion process is being continued and executes a first-image expansion process (t15). At that time, the ASIC 52 terminates the third-image expansion process and stores the third image data in the storage area 54b and prints the third image (t15). Subsequently, the CPU 42 terminates the fourth-image expansion process and outputs the fourth image data to erase it from the expansion area 44a, finishes the process of expanding the first image that takes shorter to expand, and places it into the output wait state (t16). At that time, the ASIC 52 executes the process of converting the page data of the input fourth image (t16). Subsequently, the CPU 42 outputs the expanded page data of the fifth image in the output wait state to erase it from the expansion area 44a (t17). At that time, the ASIC 52 stores the converted fourth image in the storage area 54b and prints it and, because no available storage area 54b is present, erases page data that takes the shortest to expand, here, the first-image page data, from the storage area 54b to form the conversion area 54a (S620 and S630), in which the CPU 42 executes the process of converting the input fifth-image page data (t17). Subsequently, the CPU 42 outputs the first-image page data to erase the page data from the expansion area 44a (t18). At that time, the ASIC 52 stores the converted fifth image in the storage area 54b and prints it and converts the input first-image page data (t18). The ASIC 52 stores the converted first image in the storage area 54b and prints it (t19). On the other hand, the CPU 42 places the second-image page data stored in the storage area 54b, which is an expansion page to be printed next, into the print wait state (S610), and executes the process of expanding the third image (t19). Thus, the printer 20 of the second embodiment stores data that takes longer to expand as coloring-material-amount page data in the RAM 54 of the print mechanism 21 so as to reduce expansion processing time with limited storage capacity.

The printer 20 of the second embodiment, described in detail above, is configured, in printing multiple copies of a plurality of images, to expand image data into coloring-material-type page data and, among the data, to store coloring-material-amount page data that takes longer to expand in the RAM 54 having two or more storage areas (the conversion area 54a and the storage area 54b). Thus, the printer 20 stores coloring-material-amount page data that takes longer to expand in the RAM 54 on a priority basis and uses this stored page data for the next printing process. This reduces the storage area of the RAM 54 to be used and processing time as compared with those that store all the coloring-material-amount page data. Moreover, since the printer 20 stores data in the storage area 54b while reserving the conversion area 54a for converting a plurality of pieces of image data in parallel, the printer 20 can reduce processing time by storing data that takes longer to expand while executing the process of conversion to coloring-material-amount page data. Furthermore, when an available conversion area 54a is absent, the storage area 54b in which coloring-material-amount page data that takes the shortest to expand is freed up to be used as the conversion area 54a, so that processing time can easily be reduced. Furthermore, when the conversion process has finished, the printer 20 stores the converted coloring-material-amount page data in the conversion area 54a serving as the storage area 54b. This eliminates the need for moving converted data to another area to store it. This allows storage areas to be used efficiently and reduces processing load. Moreover, since the printer 20 stores coloring-material-amount page data that is used directly for printing, the stored data can be printed without conversion, thus further reducing overall processing time. Furthermore, since the printer 20 stores coloring-material-amount page data that takes longer to expand on the basis of expansion time measured by the timer 47, storage areas to be used can be decreased more and processing time can be reduced more using the measured expansion time. Since the printer 20 is equipped with the print mechanism 21, the printer 20 can execute printing soon using the coloring-material-amount page data converted using expanded coloring-material-type page data.

### Third Embodiment

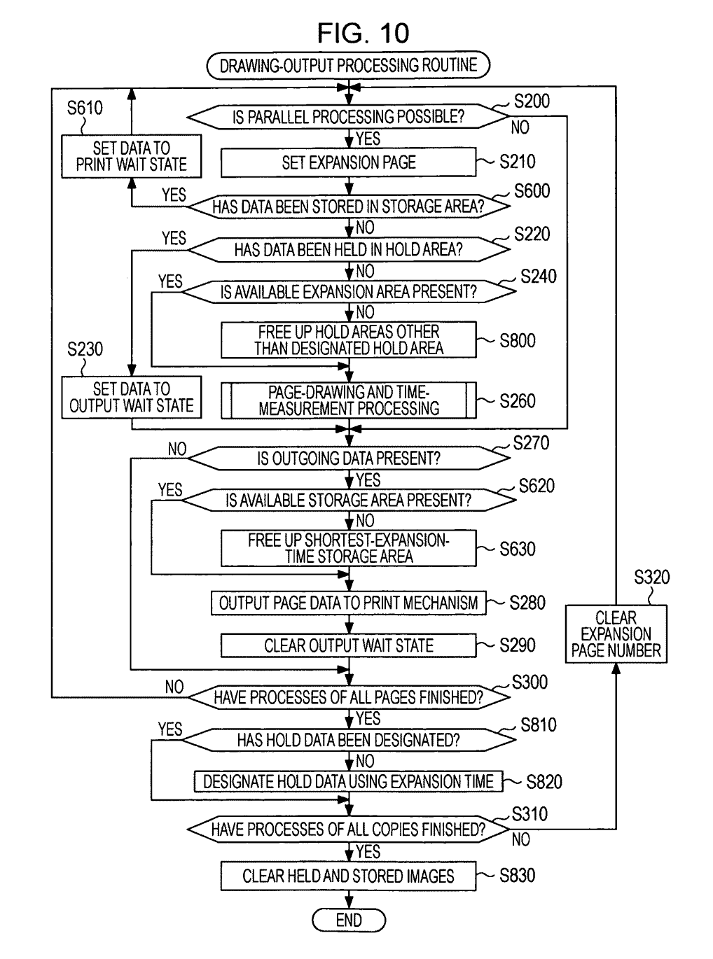

A third embodiment will be described in which the printer 20 executes printing of multiple copies of multiple pages while storing print data in the RAM 44 of the host controller 41 and the RAM 54 of the print mechanism controller 51. The host controller 41 executes the process of expanding image data to coloring-material-type page data. The print mechanism controller 51 executes the process of converting the coloring-material-type page data to coloring-material-amount page data; the process of storing this coloring-material-amount page data in the storage area 54b on the basis of expansion time and the process of storing coloring-material-type page data that takes longer next to the page data stored in the storage area 54b. The expansion time varies greatly depending on the content of image data, while the converting process hardly varies. Therefore, the coloring-material-amount page data is stored on the basis of not conversion time but expansion time. FIG. 10 shows an example of the flowchart of the drawing-output processing routine of the third embodiment executed by the CPU 42 of the control unit 40. Processes similar to the drawing-output processing routine shown in FIGS. 3 and 7 and the conversion print processing routines shown in FIGS. 5 and 8 are given the same signs and their descriptions will be omitted. When the drawing-output processing routine of FIG. 10 is started, first, the CPU 42 determines in step S200 whether parallel processing is possible. If the parallel processing is possible, the CPU 42 sets an expansion page in step S210 and determines in step S600 whether the coloring-material-amount page data of this set expansion page has been stored in the storage area 54b of the RAM 54 of the print mechanism controller 51. If this coloring-material-amount page data has been stored in the storage area 54b, then the CPU 42 sets this page data into a print wait state and executes the processes from step S200.

In contrast, if this coloring-material-amount page data has not been stored in the storage area 54b, then the CPU 42 determines in step S220 whether the coloring-material-type page data has been held in the hold area 44b. If the set coloring-material-type page data is held in the hold area 44b, the CPU 42 determines in step S240 whether an available expansion area 44a in which expansion processing can be executed is present. If an available expansion area 44a is absent, the CPU 42 frees up one of the hold areas 44b other than an area that stores coloring-material-type page data that is designated to be held in the hold area 44b and sets the freed area as the expansion area 44a (step S800). Here, in printing of the first copy, data to be held in the hold area 44b is set to coloring-material-type page data that takes longer to expand and, in printing of the second and consecutive copies, data to be held in the hold area 44b is set to coloring-material-type page data that takes the third and fourth longest to expand which are next to those stored in the storage area 54b and taking the first and second to expand. That is, in the printing of the first copy, the expansion times of all the image data are grasped and, in the printing of the second and consecutive copies, data that takes longer to expand is stored as coloring-material-amount page data in the storage area 54b, and data that takes the second longest to expand is stored as coloring-material-type page data in the hold area 44b. If an available expansion area 44a is present after step S800 or at step S240, the CPU 42 executes the page-drawing and time-measurement processing routine shown in FIG. 4 in step S260 to execute the process of expanding image data to coloring-material-type page data and determines in step S270 whether outgoing coloring-material-type page data is stored in the RAM 44. If outgoing coloring-material-type page data is present, the CPU 42 determines in step S620 whether the RAM 54 has an available conversion area 54a where conversion processing can be performed. If an available storage area 54b is absent, the CPU 42 frees up one of the storage area 54b in which coloring-material-amount page data that takes the shortest to expand in step S630 and sets the freed-up conversion area 54a as the conversion area 54a. If an available conversion area 54a is present after step S630 or in step S620, the CPU 42 outputs coloring-material-type page data to the RAM 54 of the print mechanism controller 51 of the print mechanism 21 in step S280 and, in step S290, cancels the output wait state that is set to the output data. In response to it, in the conversion print processing routine shown in FIG. 8, the ASIC 52 of the print mechanism controller 51 of the print mechanism 21 converts the coloring-material-type page data to the coloring-material-amount page data in step S520 and prints coloring-material-amount page data in the print wait state in order of the pages of print image data.

If no outgoing data is present after step S290 or at step S270, the CPU 42 determines in step S300 whether the expansion process, output process, and conversion process have finished all the pages of the image data. If the processes have not finished for all the pages, the CPU 42 repeatedly executes the processes from step S200. If it is determined that the processes have finished for all the pages, the CPU 42 determines whether coloring-material-type page data to be held in the hold area 44b has been designated (S810) and designates coloring-material-type page data to be held in the hold area 44b using the expansion times of all the pages which were stored in the RAM 44 in step S440 of the page-drawing and time-measurement processing routine of FIG. 4 (step S820). This routine is set such that coloring-material-type page data that is the third and fourth longest to expand is designated to be held. Information of this coloring-material-type page data to be held is also stored in a specified area of the RAM 44. If hold data has been designated after step S820 or at step S810, it is determined step S310 whether the above processes have finished for all the copies. If the processes for all the copies have not finished, the CPU 42 clears the expansion pages in step S320 to bring the top page and repeatedly executes the processes from step S200. That is, the CPU 42 places coloring-material-amount page data that takes longer to expand which is stored in the storage area 54b in the print wait state in step S610, thereby omitting expansion processing and conversion processing to reduce processing time. On the other hand, if the above processes for all the copies have finished in step S310, the CPU 42 clears the coloring-material-type page data held in the hold area 44b and the coloring-material-amount page data stored in the storage area 54b (step S830) and terminates this routine. This embodiment is configured to dynamically set a plurality of storage areas to store coloring-material-amount page data that takes longer to expand in the RAM 54 and to hold coloring-material-type page data that takes the second longer in the RAM 44 and to use this data for the second and consecutive print processing, thereby further reducing processing time with the limited storage areas.

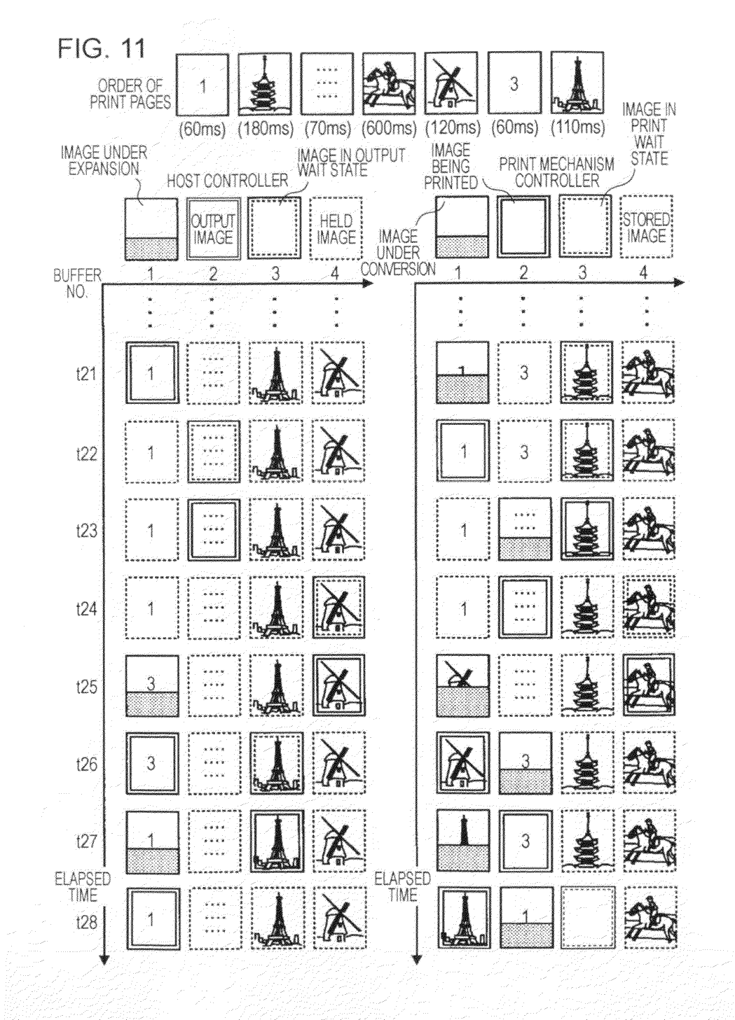

The above processes will be described using a concrete example. FIG. 11 is an image diagram showing temporal expansion processing and conversion processing. Here, expansion processing and conversion processing similar to those of FIG. 9 are shown in the same manner as FIG. 9, in which multiple copies of seven pieces of image data are printed. The following description is given the step numbers of the above-described routines, and descriptions of measurement of expansion time will be omitted. Time-lapse processing from a state in which the first-copy printing has finished, coloring-material-amount page data that takes the longest to expand is stored in the storage area 54b (the fourth and second images), and coloring-material-type page data that takes the second longest to expand (the fifth and seventh images) is held in the hold area 44b will be described (for example, printing of the third and consecutive copies). When a print instruction is given, as shown in the second embodiment, the CPU 42 repeats the process of storing the coloring-material-amount page data converted in the conversion area 54a in the storage area 54b and printing it and, if an available conversion area 54a is absent, freeing up a storage area 54b in which page data that takes the shortest to expand as the conversion area 54a. This causes the RAM 54 to store coloring-material-amount page data that takes longer to expand. Thus, the storage area 54b stores the coloring-material-amount page data that takes the longest to expand. In the second-copy printing, the CPU 42 repeats the process of designating coloring-material-type page data that is the longest to expand next to that stored in the storage area 54b, and freeing up hold areas 44b other than that storing designated page data to use it as the expansion area 44a, thereby holding the designated page data (steps S800 and S820), so that this page data is held in the hold area 44b (t21), as shown in FIG. 11. In printing of the third copy, the CPU 42 executes the process of expanding the first image and after the first-image expansion processing has finished, the CPU 42 outputs the first image data to the print mechanism controller 51 (S260 and S280), and places the coloring-material-amount page data of the second image stored in the storage area 54b into the print wait state (S610, t21). In response to it, the ASIC 52 converts the coloring-material-type page data of the first image to coloring-material-amount page data (S520). Next, the ASIC 52 terminates the first-image conversion process and stores the data in the storage area 54b and print it (S710 and S530, t22). At that time, the CPU 42 places the third image held in the hold area 44b into the output wait state (S230, t22). Next, since an available conversion area 54a is absent, the CPU 42 frees up an area in which page data in the storage area 54b which takes the shortest to expand (here, a sixth image) to use it as the conversion area 54a (S620 and S630) and outputs the page data of the third image (t23). In response to it, the ASIC 52 converts the page data of the third image and executes the process of printing the second image (t23). Next, the CPU 42 places the page data of the fourth image stored in the storage area 54b into the print wait state (S610) and places the page data of the fifth image held in the hold area 44b into the print wait state (S230, t24). At that time, the ASIC 52 executes the process of printing the third image (t24). Next, since an available conversion area 54a is absent, the CPU 42 frees up an area of the storage area 54b in which page data that takes the shortest to expand (here, the first image) is stored to use it as the conversion area 54a, outputs the page data of the fifth image and, since an available free expansion area 44a is absent, the CPU 42 frees up an area of the hold area 44b which is not designated and in which page data (first image) that takes the shortest to expand to use it as the expansion area 44a, in which the CPU 42 expands the six image (t25). At that time, the ASIC 52 executes the process of converting the received fifth image and the process of printing the fourth image (t25). Next, since an available conversion area 54a is absent, the CPU 42 frees up an area of the storage area 54b in which page data that takes the shortest to expand (the third image) is stored to use it as the conversion area 54a, outputs the page data of the sixth image and, places the page data of a seventh image held in the hold area 44b into the output wait state (t26). At that time, the ASIC 52 executes the process of converting the received sixth image and the process of printing the fifth image (t26). Next, since conversion area 54a is absent, the CPU 42 frees up an area of the storage area 54b in which page data that takes the shortest to expand (the fifth image) is stored to use it as the conversion area 54a, outputs the page data of the seventh image and, since an available expansion area 44a is absent, the CPU 42 frees up an area of the hold area 44b which is not designated and in which page data that takes the shortest to expand (the sixth image) is stored to use it as the expansion area 44a and executes the process of expanding the first image (t27). At that time, the ASIC 52 executes the process of converting the received seventh image and the process of printing the sixth image (t27). Since an available conversion area 54a is absent, the CPU 42 frees up an area of the storage area 54b in which page data that takes the shortest to expand (here, the sixth image) is stored to use it as the conversion area 54a, outputs the page data of the first image, and places the page data of the second image stored in the storage area 54b into the print wait state (t28). At that time, the ASIC 52 executes the process of converting the received first image and the process of printing the seventh image (t28). This embodiment is configured to store data that takes longer to expand as coloring-material-amount page data in the RAM 54 of the print mechanism 21 and to next store coloring-material-type page data the second longest to expand in the RAM 44 of the control unit 40 to make the most of the limited storage capacity, thereby reducing expansion processing time with the limited storage areas.

Now, the correspondence between the components of the embodiments and the components in the claims will be described. The RAM 44 and the RAM 54 of the embodiments correspond to the storage section of the claims; the CPU 42 and the ASIC 52 correspond to the conversion section; the timer 47 and the CPU 42 correspond to the time measurement section; the CPU 42 corresponds to the storage control section; the expansion area 44a and the conversion area 54a correspond to the conversion area; the hold area 44b and the storage area 54b correspond to the accumulation area; and the coloring-material-type page data and the coloring-material-amount page data correspond to print data. The embodiments show an example of the image processing method of the claims by describing the operation of the printer 20.

The printer 20 of the third embodiment offers the same advantages as in the first and second embodiments. This printer 20 stores coloring-material-type page data in the hold area 44b provided in the control unit 40 and stores coloring-material-amount page data in the storage area 54b provided in the print mechanism 21. Therefore, since relatively versatile coloring-material-type page data is stored in the print mechanism 21 and coloring-material-amount page data that is used directly in printing is stored in the print mechanism 21, the time required for printing can be further reduced. At that time, since coloring-material-amount page data that takes longer to expand to the coloring-material-type page data is stored in the storage area 54b of the RAM 54, and coloring-material-type page data that takes longer to expand next to the coloring-material-amount page data stored in the storage area 54b is stored in the hold area 44b. Therefore, image data that takes longer to convert is converted to coloring-material-amount page data that takes no time to convert and is stored in the print mechanism 21, so that conversion time is reduced, and image data that takes the second longest to process is converted to coloring-material-type page data and is stored, so that storage areas to be used is further reduced an processing time is further reduced.

It is needless to say that the invention is not limited to the above embodiments and various modification can be made without departing from the technical scope of the invention.

For example, the above embodiments dynamically switch between the expansion area 44a and the hold area 44b, and the conversion area 54a and the storage area 54b to execute expansion processing, conversion processing, holding and storing of data. Alternatively, a storage area 1 of the RAM 44 may be fixedly used as the expansion area 44a, and a storage area 2 may be used as the hold area 44b. Although this configuration also needs to move data between the areas, this further reduces processing time by omitting expansion processing.

The first and third embodiments are configured to erase coloring-material-type page data that takes the shortest to expand to reserve the expansion area 44a and to hold coloring-material-type page data that takes longer to expand in the hold area 44b. Alternatively, any method may be used to hold coloring-material-type page data that takes longer to expand; for example, longer coloring-material-type page data may be held in the hold area 44b or, coloring-material-type page data that takes not the shortest but shorter to expand may be erased. Likewise, coloring-material-type page data that takes not the longest but longer to expand may be held in the hold area 44b. This configuration can also further reduce a storage area to be used and further reduce processing time. This also applies to the coloring-material-amount page data to be stored in the storage area 54b of the second and third embodiments.

Although the above embodiments have been described when applied to the case in which the RAM 44 has four areas including the expansion areas 44a and hold areas 44b, the RAM 44 may have any number of areas more than one areas. Specifically, the above embodiments are configured such that the RAM 44 has two A2-size of storage capacity and an A3-size image is printed, in which eight areas can be provided when an A4-size image is printed. This also applies to the RAM 54.

Although the above embodiments are configured to execute expansion processing and conversion processing of two pieces of image data in parallel, the invention is not limited to that; three or more pieces of image data may be processed in parallel or, may not be processed in parallel. In this case, it is preferable that the number of memories of the hold area 44b of the RAM 44 be larger than that of the expansion area 44a.

Although the above embodiments are configured to execute outputting and conversion processing after completion of expansion processing, outputting may be performed during expansion processing if possible and conversion processing and expansion processing may be executed in parallel. This allows conversion processing to be performed before completion of expansion processing, thus further reducing printing time.

Although the above embodiments have one print mechanism 21, the invention may have more than one print mechanisms 21. In this case, the first and third embodiments may be configured to execute what is called distributed printing in which coloring-material-type page data held in the hold area 44b of the RAM 44 is printed using more than one print mechanisms. Thus further reduces processing time as compared with a configuration-in which coloring-material-amount page data that is converted in consideration of the characteristics of individual print mechanisms 21 since the distributed printing is executed while storing relatively versatile coloring-material-type page data.

Although the above embodiments are configured to actually measure expansion time using the timer 47, the invention may be configured to estimate expansion time for the CPU 42 to convert image data to print data from at least one of the number and kind of drawing instructions included in print data and to set data to be stored in the hold area 44b and the storage area 54b according to the estimated expansion time. This further reduces storage areas to be used for expansion processing using the expansion time estimated from the drawing instructions and further reduces processing time. Particularly, since expansion time is not actually measured, it can be determined before execution of expansion processing which data should be stored.

Although the above embodiments are configured to expand image data to coloring-material-type page data and then convert the data to coloring-material-amount page data, coloring-material-amount page data may be generated directly from image data. For example, in the first embodiment, the CPU 42 may have the function of the ASIC 52 so that the hold area 44b holds coloring-material-amount page data and the coloring-material-amount page data that is expanded and converted in the CPU 42 may be output to the print mechanism 21. This also further reduces processing time with limited storage areas. Although the above embodiments are configured such that the CPU 42 of the control unit 40 executes data storage management of the RAM 44 and the RAM 54, such as freeing up the hold area 44b and the storage area 54b, the print mechanism 21 may have a CPU, with which the storage management of the RAM 54 may be performed.

Although the above embodiments are configured to use print data stored in the RAM 44 and the RAM 54 directly for printing, this stored print data may be used for what is called variable printing in which individual pieces of data are written to specified locations of the stored print data. Specifically, print data is stored as original data in the hold area 44b, for example. The content of serial data to be written to an image (for example, the number of pages and destination company name) and the layout are set by means of the operation panel 46. Then, the CPU 42 copies designated coloring-material-type page data in another available storage area, generates page data in which serial data having the designated content is arranged in the designated location, and outputs the page data to the print mechanism 21 for printing. The stored print data may be used in such a way.

Although the above embodiments are configured such that the print head 24 adopts a system in which voltage is applied to a piezoelectric element to deform the piezoelectric element, thereby pressurizing ink. The invention may adopt a system in which voltage is applied to a heating resistor (for example, a heater) to heat ink, thereby generating bubbles, with which the ink is heated. Although the ink cartridge 26 has a so-called on-carriage structure in which the ink cartridge 26 is mounted on the reciprocating carriage 22, the invention may have an ink cartridge having a so-called off-carriage structure in which the ink cartridge is mounted on the frame 29 and ink is supplied to the print head 24 through tubes. Although the print mechanism 21 has the carriage 22 that moves in the carriage moving direction, the print mechanism 21 may have a so-called line ink jet head having a color nozzle train across the width of the recording paper S.

Although the above embodiments are configured such that the printer 20 is equipped with the print mechanism 21, the invention may be a multifunction printer equipped with a scanner or, alternatively, a facsimile machine. The print mechanism 21 may not be mounted to the control unit 40 and may be mounted to another unit. Although the above embodiments have been described as the printer 20, the invention may be any image processing apparatuses that convert image data to print data when printing multiple copies of multiple images and store print data that takes longer to expand on the basis of expansion time at that time; for example, digital cameras, digital video players, portable telephones, TVs, personal computers, portable video game machines, home video game machines, video recorders (video tape recorders and HDD decks), and photo-viewers, personal digital assistants (PDAs). Although the invention has been described in the form of the printer 20, the invention may be a method for processing images or a program for the method.

What is claimed is:

1. An image processing apparatus, comprising:
a storage section that can provide more than one storage area for storing print data for use in printing;
a conversion section that converts image data to the print data; and
a storage control section configured to, when printing multiple copies of multiple images, store print data that takes longer to convert in the storage section in accordance with conversion times taken to convert the individual pieces of print data.

2. The image processing apparatus according to claim 1, wherein
the conversion section can convert a plurality of pieces of image data in parallel;
the storage section can use a predetermined number of conversion areas that are necessary for the conversion section to execute the conversion processing and an accumulation area that stores the print data as the storage areas; and
the storage control section is configured to store print data determined according to the conversion times in the accumulation area while reserving the conversion area.

3. The image processing apparatus according to claim 2, wherein, the storage control section is configured to, when the conversion area is full, store the print data in the accumulation area while reserving the conversion area by erasing print data taking shorter to convert and stored in the storage area.

4. The image processing apparatus according to claim 2, wherein, the storage control section is configured to, when the conversion section performs the conversion processing, store print data subjected to the conversion processing in the conversion area of the storage section and, when the conversion processing has finished, store the converted print data in the conversion area serving as the accumulation area.

5. The image processing apparatus according to claim 1, wherein
the conversion section converts the image data to coloring-material-type page data serving as the print data which is the page data of the types of individual coloring materials; and
the storage control section is configured to store, as the print data, the coloring-material-type page data in the storage areas.

6. The image processing apparatus according to claim 1, wherein
the conversion section converts the image data to coloring-material-amount page data serving as the print data which is the page data of the amounts of individual coloring materials; and
the storage control section is configured to store, as the print data, the coloring-material-amount page data in the storage areas.

7. The image processing apparatus according to claim 1, wherein
the conversion section can convert the image data to coloring-material-type page data serving as the print data which is the page data of the types of individual coloring materials and can convert the image data to coloring-material-amount page data serving as the print data which is the page data of the amounts of individual coloring materials;
the storage section has storage areas including a storage area provided at a print mechanism that executes printing and a hold area provided at a control unit that outputs data to the print mechanism; and
the storage control section is configured to, in storing print data that takes longer to convert in the storage section, store the coloring-material-type page data in the hold area provided at the control unit and to store the coloring-material-amount page data in the storage area provided at the print mechanism.

8. The image processing apparatus according to claim 7, wherein
the storage control section is configured to store the coloring-material-amount page data that takes longer to convert the image data to the coloring-material-type page data in a storage area provided at the print mechanism and to store coloring-material-type page data, which takes the second longest to the coloring-material-amount page data stored in the storage area to convert the image data to the coloring-material-type page data, in the hold area provided at the control unit.

9. The image processing apparatus according to claim 1, further comprising:
a time measurement section that measures conversion times that the conversion section takes to convert individual pieces of image data to the print data; wherein
the storage control section is configured to store print data that takes longer to convert on the basis of the measured conversion times.

10. The image processing apparatus according to claim 1, further comprising
a time estimation section that estimates conversion times taken to convert the individual pieces of image data to the print data on the basis of at least one of the number and the kind of drawing instructions included in the image data; wherein
the storage control section is configured to store print data that takes longer to convert on the basis of the estimated conversion times.

11. The image processing apparatus according to claim 1, further comprising a print mechanism that executes printing on a print medium using print data stored in the storage section.

12. An image processing method using an image processing apparatus that includes a storage section having storage areas having more than one predetermined number of memories for storing print data-for use in printing, the method comprising:
(a) converting image data to the print data; and
(b) when printing multiple copies of multiple images, storing print data that takes longer to convert in the storage section in accordance with conversion times taken to convert the individual pieces of print data.

13. A recording medium, having a program for causing one or a plurality of computers to execute process comprising the steps of:
(a) converting image data to the print data; and
(b) when printing multiple copies of multiple images, storing print data that takes longer to convert in the storage section in accordance with conversion times taken to convert the individual pieces of print data.
